(19) United States
(12) Patent Application Publication
(10) Pub. No.: US 2008/0013992 A1
(43) Pub. Date: Jan. 17, 2008

(54) FIXING DEVICE AND IMAGE FORMING APPARATUS

(76) Inventors: Yoshihiro Fukuhata, Hyogo (JP); Masahiro Yagi, Ibaraki (JP); Shigeru Obata, Ibaraki (JP)

Correspondence Address: HARNESS, DICKEY & PIERCE, P.L.C., P.O. BOX 8910, RESTON, VA, 20195, US

(21) Appl. No.: 11/770,959

(22) Filed: Jun. 29, 2007

(30) Foreign Application Priority Data
Jul. 12, 2006 (JP) 2006-191109

(51) Int. Cl. G03G 15/20

(52) U.S. Cl. 399/331

(57) ABSTRACT

A pressurizing unit includes an elastic member that has an entering portion on a side from where a recording medium enters a nip portion, an exit portion on a side from where the recording medium exits the nip portion, and a center portion between the entering portion and the exit portion. The elastic modulus of the center portion is higher than elastic moduli of the entering portion and the exit portion.

### CROSS-REFERENCE TO RELATED APPLICATIONS

The present document incorporates by reference the entire contents of Japanese priority document, 2006-191109 filed in Japan on Jul. 12, 2006.

### BACKGROUND OF THE INVENTION

1. Field of the Invention

The present invention relates to a fixing device and an image forming apparatus that includes the fixing device.

2. Description of the Related Art

A typical fixing device that fixes an unfixed toner image on a recording medium by applying pressure and heat thereto includes a heating unit and a pressurizing unit. The heating unit includes an elastic layer and a heat source and the pressurizing unit includes an endless member and a pressurizing member. The recoding medium with an unfixed toner image thereon is conveyed to a nip portion between the heating unit and the pressurizing unit so that the unfixed toner image is fixed to the recoding medium. Various types of such fixing devices that employ the belt-nip method have been proposed. In the belt-nip method, a nip portion is formed in a way that a pressurizing member is pressed against a heating roller that is rotatable and that includes an elastic layer with the surface elastically deformable. The pressurizing member locally deforms a portion of the heating roller on a side from where a recording medium exits the nip portion. However, such deformation tends to change the surface speed of the fixing roller, causing shift of an image on the recording medium. In addition, a hard member is pressed against the elastic layer of the heating roller to locally cause deformation of the elastic layer so that a nip portion having a small curvature is formed. Hence, a large load is applied to the recording medium, for example, an amount of damage on the recoding medium or curling of the recoding medium increases.

To deal with such inconvenience, Japanese Patent Application Laid-open No. 2004-045780 discloses a pressurizing unit including an entering pad on a side from which a recording medium enters a nip portion, an exit pressurizing roller on a side from which the recording medium exits the nip portion, and a center pad between the entering pad and the exit pressurizing roller. The entering pad, the center pad, and the exit pressurizing roller are pressurized individually. The center portion of the pressurizing unit has a lower surface so as to have a V-shaped portion.

Japanese Patent Application Laid-open No. H8-166734 discloses a technology for preventing an image on a recording medium from shifting. Near the exit of a nip portion, a pressurizing roller around which a pressurizing belt extends is pressed against a fixing roller with the surface on which an elastic layer is provided. Accordingly, the elastic layer deforms and the deformation helps a recording medium to be released from fixing roller. An auxiliary roller that includes an elastic layer is provided to an upstream portion in a direction of conveyance of the recording medium. The auxiliary roller is pressed against the fixing roller to prevent the recording medium from being conveyed at a speed higher than that of the surface speed of the fixing roller, thus preventing an image from shifting on the recording medium. The shifting of the image can be effectively prevented when the total of the pressure from the auxiliary roller and the pressure from a tensile force of the pressurizing belt is larger than that from the pressurizing roller.

Japanese Patent Application Laid-open No. H8-262903 discloses an image fixing device that includes a heating-fixing roller, an endless belt, and a pressuring pad. The heating-fixing roller has the surface elastically deformable. The endless belt can be driven while making a physical contact with the heating-fixing roller. The pressurizing pad is not rotatable and positioned on the inner surface of the endless belt. The pressurizing pad presses the endless belt against the heating-fixing roller so that a belt nip through which a sheet passes is formed between the endless belt and the heating-fixing roller and that the surface of the heating-fixing roller elastically deforms. The pressurizing pad presses the endless belt against the heating-fixing roller such that a pressure applied to the sheet at the entrance of the belt nip is smaller than a pressure applied to the sheet at the exit of the belt nip. The pressurizing pad is covered with a friction-reducing sheet, and a lubricant is applied to the inner surface of a pressurizing belt.

Japanese Patent Application Laid-open No. H8-262903 discloses a thermal fixing roller that includes a core around which silicon rubber is formed. The silicon rubber has hardness equal to 35 degrees (JIS A) or smaller, a permanent deformation equal to 10% or smaller, a thickness of 1.5 mm to 4 mm.

Japanese Patent Application Laid-open No. 2002-207388 discloses an image forming unit that includes a pressurizing belt, a pressurizing-belt supporting member, and a pressuring unit. The pressurizing belt presses a recording medium against a heating-fixing roller. The pressurizing-belt supporting member includes a plurality of supporting members around which the pressurizing belt extends. The pressing unit presses the recording medium between the heating-fixing roller and the outer surface of the pressurizing belt. As the pressing unit, at least a pair of pressing members is provided such that one of the pressing members is positioned on the inner surface of the heating-fixing roller and the other pressing member is positioned on the inner surface of the pressurizing belt.

### SUMMARY OF THE INVENTION

It is an object of the present invention to at least partially solve the problems in the conventional technology.

A fixing device according to one aspect of the present invention includes a heating unit and a pressurizing unit, and that fixes an unfixed toner image on a recording medium by applying heat with the heating unit and pressure with the pressurizing unit to the unfixed toner image on the recording medium located in a nip portion between the heating unit and the pressurizing unit. The pressurizing unit includes an elastic member, the elastic member having an entering portion on a side from where the recording medium enters the nip portion, an exit portion on a side from where the recording medium exits the nip portion, and a center portion between the entering portion and the exit portion, an elastic modulus of the center portion being higher than elastic moduli of the entering portion and the exit portion.

A fixing device according to another aspect of the present invention includes a heating unit and a pressurizing unit, and that fixes an unfixed toner image on a recording medium by applying heat with the heating unit and pressure with the pressurizing unit to the unfixed toner image on the recording medium located in a nip portion between the heating unit and the pressurizing unit. The pressurizing unit includes an elastic member, the elastic member having an entering portion on a side from where the recording medium enters the nip portion, an exit portion on a side from where the recording medium exits the nip portion, and a center portion between the entering portion and the exit portion, an elastic modulus of the center portion being higher than elastic moduli of the entering portion and the exit portion. The center portion has a thickness smaller than thicknesses of the entering portion and the exit portion.

An image forming apparatus according to still another aspect of the present invention includes a plurality of developing units for forming toner images of colors different from each other; a photoreceptor that has a surface on which the toner images are transferred; an intermediate transfer unit for transferring thereto a transferred toner image on the photoreceptor; a transfer unit that transfers the transferred toner image on the intermediate transfer unit to a recording medium; and a fixing device that includes a heating unit and a pressurizing unit, and that fixes an unfixed toner image on the recording medium by applying heat with the heating unit and pressure with the pressurizing unit to the unfixed toner image on the recording medium located in a nip portion between the heating unit and the pressurizing unit. The pressurizing unit includes an elastic member, the elastic member having an entering portion on a side from where the recording medium enters the nip portion, an exit portion on a side from where the recording medium exits the nip portion, and a center portion between the entering portion and the exit portion, an elastic modulus K=EA/t of the center portion being higher than elastic moduli of the entering portion and the exit portion, where E is a Young's modulus, A is an area of the nip portion, and t is a thickness of the pressurizing member in a direction of application of load.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an image forming apparatus according to a first embodiment of the present invention;

FIG. 2 is a schematic of a fixing device of the image forming apparatus;

FIG. 3 is a modification of the fixing device shown in FIG. 2;

FIG. 4 is another modification of the fixing device shown in FIG. 2;

FIG. 5 is still another modification of the fixing device shown in FIG. 2;

FIG. 6 is a diagram indicating examples of pressure distribution of the modifications of the fixing device;

FIG. 7 is a diagram indicating examples of deformation of an elastic layer of a heating-fixing roller of the fixing device in a direction of transfer of a recording medium;

FIG. 8 is a table containing results of evaluation tests on sheet releasability of the fixing device shown in FIG. 2 and its modifications shown in FIGS. 3 to 5;

FIG. 9 is a schematic of a fixing device according to a second embodiment of the present invention;

FIG. 10 is a schematic of a modification of the fixing device shown in FIG. 9;

FIG. 11 is a schematic of a modification of the fixing device shown in FIG. 9; and

FIG. 12 is a schematic of a modification of the fixing device shown in FIG. 9.

### DETAILED DESCRIPTION OF THE PREFERRED EMBODIMENTS

Exemplary embodiments of the present invention are explained in detail below with reference to the accompanying drawings.

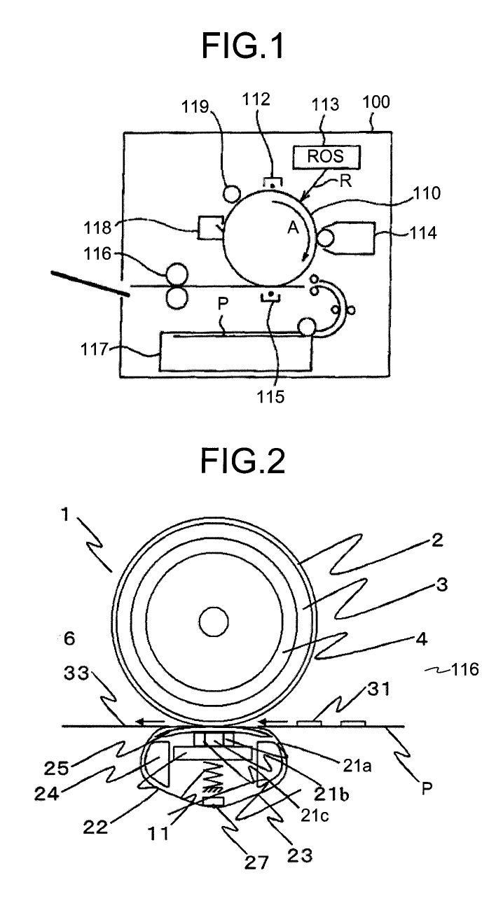

FIG. 1 is a schematic of an image forming apparatus 100 according to a first embodiment of the present invention. The image forming apparatus 100 includes a photoreceptor 110 that rotates in the direction indicated by an arrow A, a scorotron charging unit 112 that electrically charges the surface of the photoreceptor 110; a raster output scanner (ROS) 113 that forms a electrostatic latent image on the surface of the photoreceptor 110 by exposing the surface with a ray R of light modulated with information on an image, a developing unit 114 that forms a toner image on the surface of the photoreceptor 110 by developing the electrostatic latent image thereon with toner, a transfer unit 115 that transfers the toner image on the surface of the photoreceptor 110 to a paper sheet P, a fixing device 116 that fixes the toner image on the paper sheet P, a sheet tray 117 for storing therein paper sheets P, a cleaner 118 that cleans the surface of the photoreceptor 110, and a removing unit 119 that removes residual static electricity residing on the surface of the photoreceptor 110.

Operations of the image forming apparatus for forming an image are explained below with reference to FIG. 1. First, an original image signal read from an original by an image reading unit (not shown), or an original signal generated by, for example, an external computer (not shown) is input to an image processing unit (not shown) and image processing is performed properly. In this manner, an input image signal is obtained. The input image signal is input to the ROS 113 and used to modulate the ray R. The modulated ray R is applied to the surface of the photoreceptor 110 that is electrically charged by the scorotron charging unit 112. In this manner, raster scanning is performed, and thus, an electrostatic latent image that corresponds to the input image signal is formed on the surface of the photoreceptor 110.

The electrostatic latent image on the surface of the photoreceptor 110 is developed by the developing unit 114 with toner so that a toner image is formed on the surface of the photoreceptor 110. With the rotation of the photoreceptor 110, the toner image is conveyed to the transfer unit 115 that is arranged so as to be opposed to the photoreceptor 110.

Meanwhile the paper sheet P stored in the sheet tray 117 is fed to a nip portion between the photoreceptor 110 and the transfer unit 115. The transfer unit 115 transfers the toner image from the surface of the photoreceptor 110 to the paper sheet P. The paper sheet P with the toner image thereon is conveyed to the fixing device 116 and the fixing device 116 fixes the toner image. In this manner, a desired image is obtained.

After the transfer of the toner image to the paper sheet S, the cleaner 118 cleans residual toner residing on the surface of the photoreceptor 110. The removing unit 119 removes the residual static electricity residing on the surface of the photoreceptor 110. In this manner, one cycle of the operations for forming an image is completed.

FIG. 2 is a schematic of the fixing device 116 of the image forming apparatus 100. A heating-fixing roller 1 includes a surface-covering layer 2, an elastic layer 3, a core 4, and a heat source 6. The heating-fixing roller 1 is driven to rotate. A paper sheet P with unfixed toner 31 on its surface is conveyed in the direction indicated by an arrow shown in FIG. 2. A pressurizing unit is provided such that the paper sheet P is sandwiched between the heating-fixing roller 1 and the pressurizing unit. The pressurizing unit includes a pressurizing member 21, a supporting member 22 that supports the pressurizing member 21, a pressurizing spring 11 that presses the pressurizing member 21 and the supporting member 22 against the paper sheet P, an endless member 23 that is driven to rotate, a friction-reducing member 25 for reducing friction between the endless member 23 and the pressurizing member 21, and a guiding member 24 that defines a path of the endless member 23. The pressurizing member 21 is divided into three parts (an entering portion 21a on a side from where the paper sheet P exits the nip portion, an exit portion 21c on a side from where the paper sheet P exits the nip portion, and a center portion 21b between the entering portion 21a and the exit portion 21c) in a direction of conveyance of the paper sheet P (hereinafter, “sheet direction”). A lubricant-supplying member 27 supplies a lubricant for further reducing friction between the endless member 23 and the pressurizing member 21.

As a lubricant of the lubricant-supplying member 27, one containing silicon oil or fluorine oil is generally used. A fixed image 33 is obtained after the paper sheet P passes through a nip portion formed between the heating-fixing roller 1 and the endless member 23. As the surface-covering layer 2, for example, a PFA layer is used to prevent the unfixed toner 31 to be adhered to the heating-fixing roller 1. As the elastic layer 3, for instance, silicon rubber or fluororubber is generally used. When silicon rubber is used, the elastic layer 3 may be coated with, for example, a fluorine layer or the like to improve swelling resistance. The endless member 23 is made of PFA and polyimide. As the pressurizing member 21 is used a pressurizing pad with the flat surface to which a pressure is applied. The pressurizing member 21 includes an elastic member formed of silicon rubber or fluorine rubber. As the paper sheet P, any type of recording medium such as a cut sheet can be used.

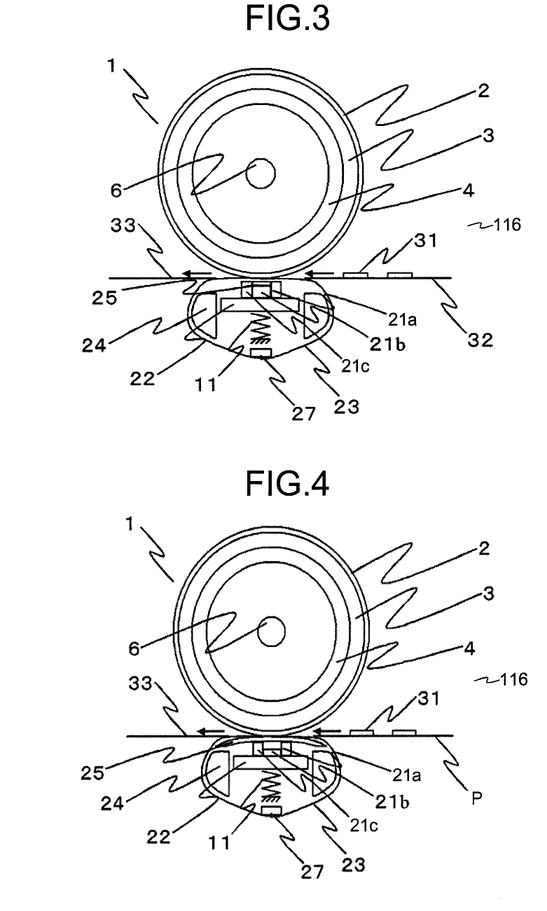

FIG. 3 is a schematic of a modification of the fixing device 116 shown in FIG. 2. In the modification, the friction-reducing member 25 is arranged above the center portion 21b. Except for the friction-reducing member 25, the structure of the modification is same as that of the fixing device 116 shown in FIG. 2.

FIG. 4 is a schematic of another modification of the fixing device 116 shown in FIG. 2. In the modification, the center portion 21b has a thickness in the direction of application of load (hereinafter, “load application direction”) smaller than the thicknesses of the entering portion 21a and the exit portion 21c, and thus the pressurizing member 21 has a concave portion. Except for this point, the structure of the modification is same as that of the fixing device 116 shown in FIG. 2.

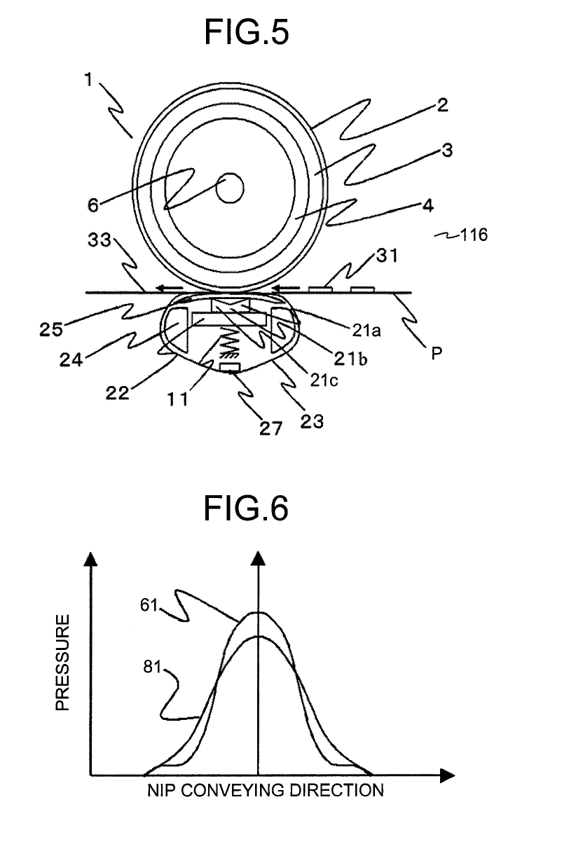

FIG. 5 is a schematic of still another modification of the fixing device 116 shown in FIG. 2. In the modification, the elastic member of the pressurizing member 21 is not divided into parts. A center portion of the pressurizing member 21 has a thickness in the load application direction smaller than the thicknesses of the entering portion and the exit portion, and thus, the pressurizing member 21 has a V-shaped portion. Except for this point, the structure of the modification is same as that of the fixing device 116 shown in FIG. 2.

FIG. 6 is a diagram indicating an example of pressure distribution, along the sheet direction, of the heating-fixing roller 1 at the nip portion. The pressure distribution is obtained when the pressurizing member 21 is pressed against the heating-fixing roller 1 in each of the types shown in FIGS. 2 to 5. The diagram also indicates another comparative example of pressure distribution. The vertical axis shown in FIG. 6 is a pressure scale and the horizontal axis is a scale of a direction in which the heating-fixing roller 1 rotates (circumferential direction) and the paper sheet P is conveyed. The diagram represents that the paper sheet P is conveyed to the nip portion between the heating-fixing roller 1 and the pressurizing member 21 from the left (from the side of the vertical axis). Hereinafter, the left side of the diagram is referred to as “nip entrance”, and the right side thereof is referred to as “nip exit”. The width of the nip portion (hereinafter, “nip width”) is a width in the sheet direction.

A curved line 81 shown in FIG. 81 is of the comparative example indicating pressure distribution obtained when the elastic member of the pressurizing member 21 has the uniform hardness and the thickness in the load application direction. For comparison, the distribution is simplified. A curved line 61 indicates the example of pressure distribution obtained with the elastic member in a shape different from that of the comparative example. Specifically, the elastic modulus of the center portion of the elastic member at the nip portion is larger than elastic moduli of the entering portion and the exit portion. The elastic modulus is K=EA/t, where K is a Young's modulus, A is an area of a nip portion, and t is a thickness of the pressurizing member in the load application direction. The conditions on the structure of the heating-fixing roller 1, the load to be applied to the elastic member, and the nip width (the width of the pressurizing pad can be changed) are the same when the pressure distributions indicated by the curved line 61 is obtained and when the pressure distribution indicated by the curved line 81 is obtained. As shown in FIG. 6, the peak pressure on the curved line 81 is lower than that on the curved line 61, and the curved line 81 indicates that the pressure varies gently from the nip entrance to the nip exit.

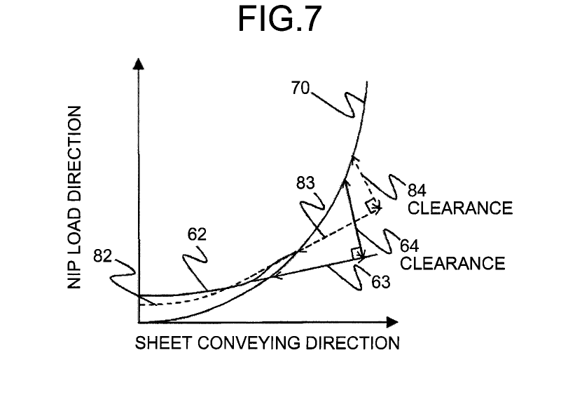

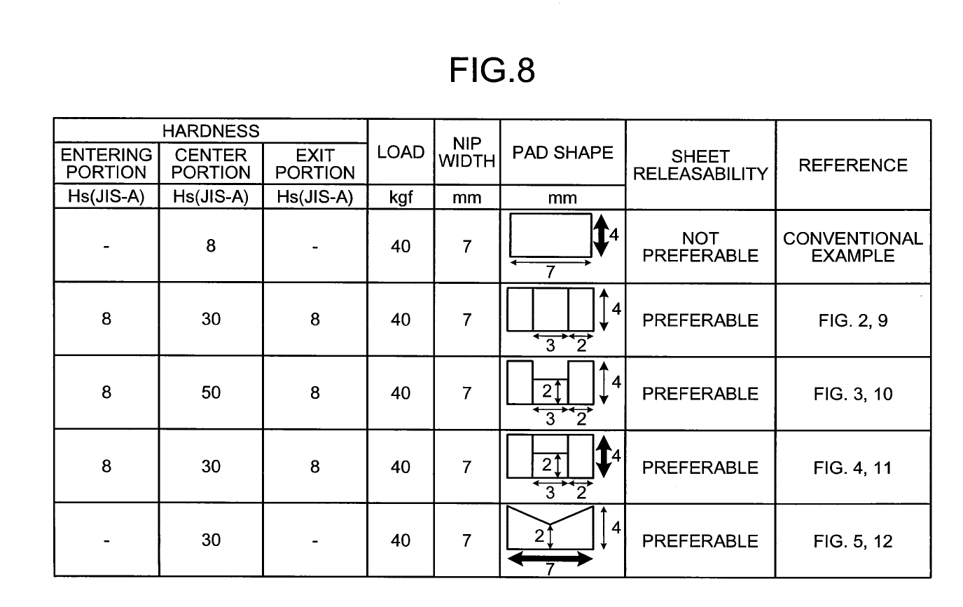

FIG. 7 is a diagram indicating an example of deformation of the elastic layer 3 of the heating-fixing roller 1 in the sheet direction. A curved line 70 represents the shape of the surface of the heating-fixing roller 1 before it deforms, and a curved line 82 represents the shape of the elastic layer 3 (hereinafter, “nip shape”) deformed with the pressure distribution indicated by the curved line 81 shown in FIG. 6. A straight line 83 represents a paper sheet that exits the nip portion along the nip shape. A clearance 84 represents a distance between a point on the curved line 70 and a point on the straight line 83 from where a line orthogonal to the straight line 83 extends to the point on the curved line 70. A curved line 62 represents the nip shape of the elastic layer 3 deformed with the pressure distribution indicated by the curved line 61 shown in FIG. 6. A straight line 63 represents a paper sheet that exits the nip portion along the nip shape. A clearance 64 represents a distance between a point on the curved line 70 and a point on the straight line 63 from where a line orthogonal to the straight line 63 extends to the point on the curved line 70. The larger the clearance 64 is, the more the paper sheet is easily released from the surface of the heating-fixing roller 1. The diagram indicates that the clearance depends largely on the amount of deformation of the elastic layer 3 and the outer surface of the heating-fixing roller 1. For this reason, an increase in the amount of modification of the elastic layer 3 in the load application direction improves releasability of the paper sheet from the heating-fixing roller 1 (hereinafter, “sheet releasability”).

FIG. 8 is a table containing the results of the evaluation tests on the sheet releasability, using fixing devices shown in FIGS. 2 to 5, each fixing device including a heating-fixing roller made by SWCC Showa Cable Systems Co., Ltd. The heating-fixing roller had an outer diameter of φ27 mm. The heating-fixing roller included an elastic layer having a thickness of 1.0 mm, a hardness of 8 Hs (JIS-A), a permanent deformation of 4%, and a length in an axial direction of 230 mm. Each of the fixing devices included a pressurizing unit, and the structures of the pressurizing units were different from one another, and a load of 40 kgf was applied to each of the fixing units for the evaluation tests. The same conditions including a certain nip width were applied to each of the evaluation tests. Note that a nip width shown in FIG. 8 is a reference value.

In the evaluation tests, a full-color image was formed and fixed on a generally used cut paper sheet with a basis weight of 55 g/cm². As a result of the evaluation tests, it was found that the pressurizing pads of the pressurizing members having the respective shapes shown in FIGS. 2 to 5 improve the sheet releasability as shown in FIG. 7 compared with the pressurizing member that has a thickness in the load application direction of 4 mm and includes an elastic member with a hardness of 8 Hs (JIS-A) and a permanent deformation of 4% and. The sheet releasability improves because the elastic layer of the heating-fixing roller deforms appropriately depending on the appropriate differences between the elastic moduli of the entering portion and the center portion of the pressurizing member and between the elastic moduli of the exit portion and the center portion thereof. The differences are equal to a value larger than a certain value. If the permanent deformation of the elastic layer of the heating-fixing roller is large, image deterioration, such as uneven gloss of an image may be caused.

The results of the evaluation tests indicated that a permanent deformation equal to 5% or larger increases the amount of uneven gloss of an image, and that a permanent deformation equal to 4% or smaller is desirable. Based on the idea that a large clearance between the surface of the heating-fixing roller and the sheet surface improves the sheet releasability, the outer surface of the heating-fixing roller is also a parameter for defining the clearance. The results also indicated that an outer diameter equal to φ27 mm or larger lowers the sheet releasability. Hence, it is desirable that the heating-fixing roller have an outer diameter equal to φ27 mm or smaller.

The test results also indicated that the thickness of the elastic layer of the heating-fixing roller is a parameter for defining the clearance. It was found that a thickness of the elastic layer equal to 0.8 mm or smaller lowers the sheet releasability because a small thickness of the elastic layer leads to a small amount of deformation of the elastic layer so that the paper sheet cannot be in an appropriate state at the nip exit. For this reason, it is desirable that the elastic layer have a thickness equal to 0.8 mm or more.

The test results also indicated that the hardness of the elastic layer of the heating-fixing roller is a parameter for defining the clearance. It was found that the hardness of the elastic layer equal to 8 Hs (JIS-A) or larger lowers the sheet releasability. The sheet releasability is lowered because a large hardness of the elastic layer leads to a small amount of the deformation of the elastic layer so that the sheet cannot be in an appropriate state at the nip exit. For this reason, it is desirable that the elastic layer have a hardness of 8 Hs (JIS-A) or smaller.

A large permanent deformation of the pressuring member may cause a temporal change of the nip shape so that the fixing characteristics of toner to the sheet and the sheet releasability are unstable. The results of the evaluation tests indicated that a permanent deformation equal to 5% or larger lowers the sheet releasability after the heating-fixing roller was heated and rotated for 100 hours or more. For this reason, it is desirable that the pressurizing member have a permanent deformation of 4% or smaller.

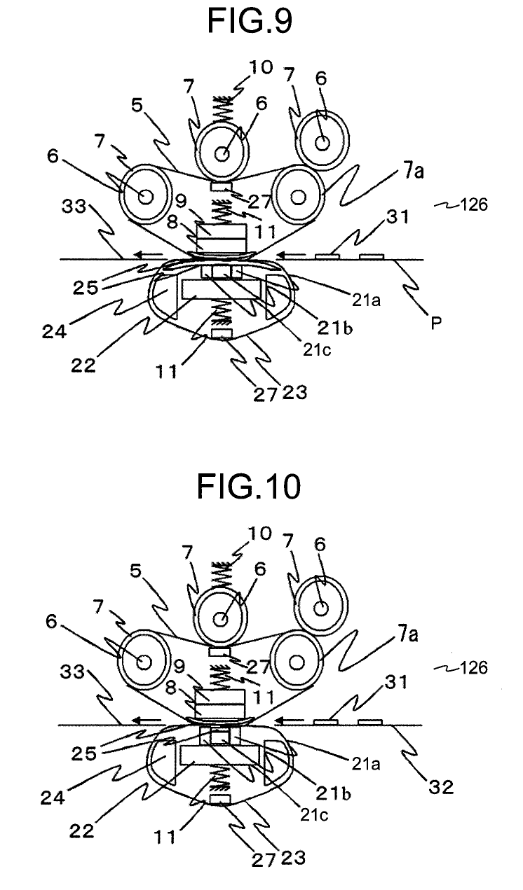

FIG. 9 is a schematic of a fixing device 126 according to a second embodiment of the present invention. The same reference numerals of the fixing device 116 are given to members of the fixing device 126 that are the same as or similar to those of the fixing device 116. The fixing device 126 includes an endless heating member 5 that faces the surface of a paper sheet P with a toner image thereon, a heating member 8 that includes an elastic layer, a pressurizing-supporting member 9 that supports the heating member 8, the heat source 6, a pressurizing spring 10, and heating rollers 7 across which the endless heating member 5 extends. The heating rollers can be configured to heat the endless heating member 5. If heat applied to the endless heating member 5 is insufficient, the heating roller 7 can be caused to be in contact with the outer surface of the endless heating member 5 to heat the endless heating member 5.

A driven roller 7a has no heat source and is driven to rotate. Each of the heating rollers 7 has a drive source to drive the endless heating member 5. Alternatively, the driven roller 7a can have a drive source. The use of the endless heating member 5 instead of the heating-fixing roller 1 allows adjustment of the nip width and the deformation of the endless heating member 5 on a side from which the paper sheet S exits from a nip portion with little change of the size of the fixing device 126. The pressurizing member 21 is divided into three parts (the entering portion 21a, the center portion 21b, and the exit portion 21c). In this structure, the width of the pressurizing member 21 needs to be equal to or smaller than the width of the heating member 8.

FIG. 10 is a schematic of a modification of the fixing device 116 shown in FIG. 9. In this example, the friction-reducing member 25 is arranged above the center portion 21b. Except for the friction-reducing member 25, the structure of the modification is same as that of the fixing device 116 shown in FIG. 9.

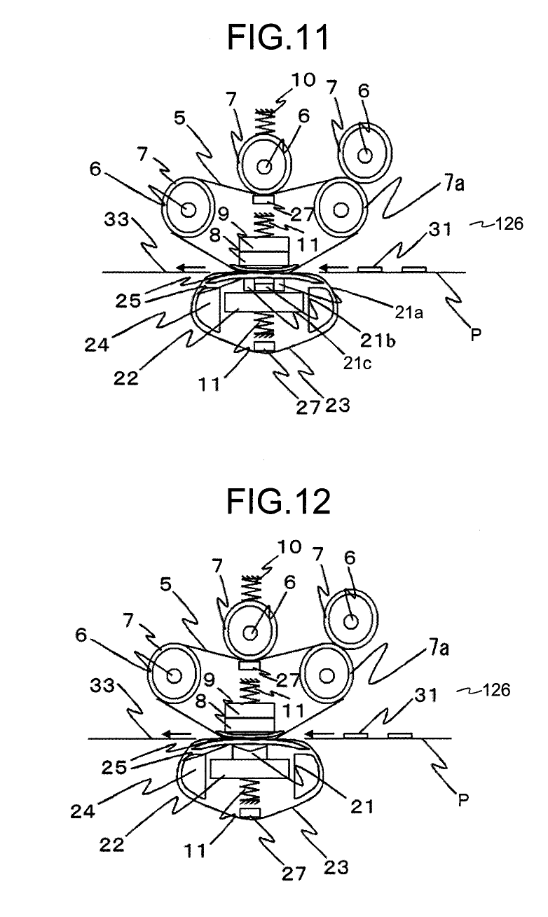

FIG. 11 is a schematic of another modification of the fixing device 116 shown in FIG. 9. In this example, the center portion 21b has a thickness in a load application direction smaller than the thicknesses of the entering portion 21a and the exit portion 21c, and thus the pressurizing member 21 has a concave portion. Except for this point, the structure of the modification is same as that of the fixing device 116 shown in FIG. 9.

FIG. 12 is a schematic of still another modification of the fixing device 116 shown in FIG. 9. In this example, the elastic member of the pressurizing member 21 is not divided into parts. A center portion of the pressurizing member 21 has a thickness in the load application direction smaller than the thicknesses of the entering portion and the exit portion, and thus, the pressurizing member 21 has a V-shaped portion. Except for this point, the structure of the modification is same as that of the fixing device 116 shown in FIG. 9.

According to the first and the second embodiments, the elastic member of the pressurizing member has the center portion having an elastic modulus larger than the elastic moduli of the entering portion and the exit portion, and has the thickness in the load application direction smaller than the thicknesses of the entering portion and the exit portion. Hence, the elastic layer of the heating-fixing roller, or the elastic layer of the endless heating member, locally deforms so that the sheet can be in an appropriate state at the nip exit. This reduces the amount of the shift of an image on a recording medium and a load applied to the recording medium, and the sheet releasability improves effectively.

According to the first and the second embodiments, the width of the elastic member of the pressurizing member is appropriate. Hence, the elastic layer of the heating-fixing roller, or the elastic layer of the endless heating member, locally deforms so that the sheet can be in an appropriate state at the nip exit. This reduces the amount of the shift of an image on a recording medium and a load applied to the recording medium, and the sheet releasability improves effectively. The center portion of the elastic member of the pressurizing member can have a Young's modulus larger than those of the entering portion and the exit portion. The thickness of the center portion can be smaller than the thicknesses of the entry portion and the exit portion, or the center portion can be removed, and thus, the pressurizing member can have the concave portion.

According to the first and the second embodiments, the thickness of the center portion can be smaller than those of the entering portion and the exit portion, and thus, the pressurizing member can have a V-shaped portion. The lubricant holding member can be positioned above the center portion. The elastic member of the pressurizing member can have a permanent deformation equal to 4% or smaller and a thickness in the load applying direction equal to 2 mm or smaller.

According to the first embodiment, the use of the heating-fixing roller realizes the desirable effects at a low cost. It is preferable that the heating-fixing roller has a diameter equal to 27 mm or smaller, and has the elastic layer with a hardness equal to 8 Hs (JIS-A) or smaller and a thickness equal to 0.8 mm or larger, and that the elastic layer has a permanent deformation equal to 4% or smaller.

According to the second embodiment, the use of the heating belt realizes high-speed fixing.

The use of the fixing devices according to the first and the second embodiments in an image forming apparatus makes the overall structure of the image forming apparatus simple. In addition, the fixing devices improve the releasability of the recording medium from the heating unit without application of a heavy load to the recording medium, thereby improving the quality of an image formed on the recording medium.

According to an aspect of the present invention, the amount of shift of an image on a recording medium can be reduced, a load applied to the recording medium can be reduced, and releasability of the recording medium can improve.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fixing device that includes a heating unit and a pressurizing unit, and that fixes an unfixed toner image on a recording medium by applying heat with the heating unit and pressure with the pressurizing unit to the unfixed toner image on the recording medium located in a nip portion between the heating unit and the pressurizing unit, wherein
the pressurizing unit includes an elastic member, the elastic member having an entering portion on a side from where the recording medium enters the nip portion, an exit portion on a side from where the recording medium exits the nip portion, and a center portion between the entering portion and the exit portion, an elastic modulus K=EA/t of the center portion being higher than elastic moduli of the entering portion and the exit portion, where E is a Young's modulus, A is an area of the nip portion, and t is a thickness of the pressurizing member in a direction of application of load.

2. The fixing device according to claim 1, wherein a width of the pressurizing member in a direction in which the recording medium is conveyed is equal to or narrower than a width of the nip portion obtained by pressing the pressurizing unit against the heating unit with an infinite plate.

3. The fixing device according to claim 1, wherein the center portion has the Young's modulus E higher than Young's moduli of the entering portion and the exit portion.

4. The fixing device according to claim 1, wherein a thickness of the center portion in a direction of application of load is smaller than thicknesses of the entering portion and the exit portion in the direction of application of load, or the center portion is removed, such that the elastic member has a concave portion.

5. The fixing device according to claim 1, wherein a thickness of the center portion in a direction of application of load is smaller than thicknesses of the entering portion and the exit portion in a direction of application of load such that the elastic member has a V-shaped portion.

6. The fixing device according to claim 2, wherein the pressurizing unit further includes a lubricant holding member that is positioned above the center portion.

7. The fixing device according to claim 3, wherein the pressurizing unit further includes a lubricant holding member that is positioned above the center portion.

8. The fixing device according to claim 1, wherein the elastic member has a permanent deformation equal to or smaller than 4% and a thickness equal to or thinner than 2 millimeters in a direction of application of load.

9. The fixing device according to claim 1, wherein the heating unit is a heating-fixing roller that is rotatable and that includes an elastic layer and a heat source.

10. The fixing device according to claim 9, wherein
the heating-fixing roller has an outer diameter equal to or smaller than 27 millimeters, and
the elastic layer has a hardness equal to or smaller than 8 Hs (JIS-A) and a thickness equal to or thicker than 8 millimeters.

11. The fixing device according to claim 9, wherein the elastic layer has a permanent deformation equal to or smaller than 4%.

12. The fixing device according to claim 3, wherein the heating unit includes an elastic layer, a heat source, a plurality of rollers that are rotatable, and an endless heating member that extends across the rollers.

13. The fixing device according to claim 4, wherein the heating unit includes an elastic layer, a heat source, a plurality of rollers that are rotatable, and an endless heating member that extends across the rollers.

14. The fixing device according to claim 5, wherein the heating unit includes an elastic layer, a heat source, a plurality of rollers that are rotatable, and an endless heating member that extends across the rollers.

15. An image forming apparatus comprising:
a plurality of developing units for forming toner images of colors different from each other;
a photoreceptor that has a surface on which the toner images are transferred;
an intermediate transfer unit for transferring thereto a transferred toner image on the photoreceptor;
a transfer unit that transfers the transferred toner image on the intermediate transfer unit to a recording medium; and
a fixing device that includes a heating unit and a pressurizing unit, and that fixes an unfixed toner image on the recording medium by applying heat with the heating unit and pressure with the pressurizing unit to the unfixed toner image on the recording medium located in a nip portion between the heating unit and the pressurizing unit, wherein
the pressurizing unit includes an elastic member, the elastic member having an entering portion on a side from where the recording medium enters the nip portion, an exit portion on a side from where the recording medium exits the nip portion, and a center portion between the entering portion and the exit portion, an elastic modulus K=EA/t of the center portion being higher than elastic moduli of the entering portion and the exit portion, where E is a Young's modulus, A is an area of the nip portion, and t is a thickness of the pressurizing member in a direction of application of load.

16. A fixing device that includes a heating unit and a pressurizing unit, and that fixes an unfixed toner image on a recording medium by applying heat with the heating unit and pressure with the pressurizing unit to the unfixed toner image on the recording medium located in a nip portion between the heating unit and the pressurizing unit, wherein
the pressurizing unit includes an elastic member, the elastic member having an entering portion on a side from where the recording medium enters the nip portion, an exit portion on a side from where the recording medium exits the nip portion, and a center portion between the entering portion and the exit portion, an elastic modulus K=EA/t of the center portion being higher than elastic moduli of the entering portion and the exit portion, where E is a Young's modulus, A is an area of the nip portion, and t is a thickness of the pressurizing member in a direction of application of load, and
the center portion has a thickness smaller than thicknesses of the entering portion and the exit portion.

17. An image forming apparatus comprising:
a plurality of developing units for forming toner images of colors different from each other;
a photoreceptor that has a surface on which the toner images are transferred;
an intermediate transfer unit for transferring thereto a transferred toner image on the photoreceptor;
a transfer unit that transfers the transferred toner image on the intermediate transfer unit to a recording medium; and
the fixing device according to claim 16.
